(19) United States
(12) Patent Application Publication
(10) Pub. No.: US 2005/0210427 A1
(43) Pub. Date: Sep. 22, 2005

(54) System and method for facilitating efficient application of logical configuration information in VLSI circuit analysis tools

(76) Inventors: S. Brandon Keller, Evans, CO (US); Gregory Dennis Rogers, Ft. Collins, CO (US); George Harold Robbert, Ft. Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/803,692

(22) Filed: Mar. 18, 2004

(51) Int. Cl. G06F 17/50

(52) U.S. Cl. 716/4; 716/2

(57) ABSTRACT

A method for optimizing relationships between logic commands defining a circuit design input to an analysis tool is described. The method comprises, responsive to a determination that a value of logic level of a signal can be inferred and responsive to an attempt by the analysis tool to set the logic level of the signal to a calculated value, determining whether the calculated value is equal to the inferred value; and if the calculated value is equal to the inferred value, setting the logic level of the signal to the inferred value.

### CROSS-REFERENCE TO RELATED APPLICATIONS

This application is related to the following commonly-owned, co-pending U.S. patent applications: U.S. patent application Ser. No. ______, filed ______ entitled “SYSTEM AND METHOD TO OPTIMIZE LOGICAL CONFIGURATION RELATIONSHIPS IN VLSI CIRCUIT ANALYSIS TOOLS” (Docket No. 200311735-1); U.S. patent application Ser. No. ______, filed ______ entitled “SYSTEM AND METHOD TO PRIORITIZE AND SELECTIVELY APPLY CONFIGURATION INFORMATION FOR VLSI CIRCUIT ANALYSIS TOOLS” (Docket No. 200311762-1); U.S. patent application Ser. No. ______, filed ______ entitled “SYSTEM AND METHOD FOR FLATTENING HIERARCHICAL DESIGNS IN VLSI CIRCUIT ANALYSIS TOOLS” (Docket No. 200311777-1); U.S. patent application Ser. No. ______, filed ______ entitled “SYSTEM AND METHOD FOR CONTROLLING ANALYSIS OF MULTIPLE INSTANTIATIONS OF CIRCUITS IN HIERARCHICAL VLSI CIRCUIT DESIGNS” (Docket No. 200311778-1); and U.S. patent application Ser. No. ______, filed ______ entitled “SYSTEM AND METHOD TO LIMIT RUNTIME OF VLSI CIRCUIT ANALYSIS TOOLS FOR COMPLEX ELECTRONIC CIRCUITS” (Docket No. 200311780-1); all of which are hereby incorporated by reference in their entirety.

### BACKGROUND

In the field of integrated circuit (“IC”) design and particularly very large scale integration (“VLSI”) design, it is desirable to test the design before implementation and to identify potential violations in the design. Before implementation on a chip, the information about a design, including information about specific signals and devices that comprise the design, as well as information about connections between the devices, are typically stored in a computer memory. Based on the connection and device information, the designer can perform tests on the design to identify potential problems. For example, one portion of the design that might be tested is the conducting material on the chip. In particular, representations of individual metal segments may be analyzed to determine whether they meet certain specifications, such as electromigration and self-heating specifications. Other tests that may be conducted include electrical rules checking tests, such as tests for noise immunity and maximum driven capacitance, and power analysis tests that estimate power driven by a particular signal and identify those over a given current draw. These tests may be performed using software tools referred to as VLSI circuit analysis tools.

Modern semiconductor IC chips include a dense array of narrow, thin-film metallic conductors, referred to as “interconnects”, that transport current between various devices on the IC chip. As the complexity of ICs continues to increase, the individual components must become increasingly reliable if the reliability of the overall IC is to be maintained. Due to continuing miniaturization of VLSI circuits, thin-film metallic conductors are subject to increasingly high current densities. Under such conditions, electromigration can lead to the electrical failure of interconnects in a relatively short period of time, thus reducing the lifetime of the IC to an unacceptable level. It is therefore of great technological importance to understand and control electromigration failure in thin film interconnects.

Electromigration can be defined as migration of atoms in a metal interconnect line due to momentum transfer from conduction electrons. The metal atoms migrate in the direction of current flow and can lead to failure of the metal line. Electromigration is dependent on the type of metal used and correlates to the melting temperature of the metal. In general, a higher melting temperature corresponds to higher electromigration resistance. Electromigration can occur due to diffusion in the bulk of the material, at the grain boundaries, or on the surface. For example, electromigration in aluminum occurs primarily at the grain boundary due to the higher grain boundary diffusivity over the bulk diffusivity and the excellent surface passivation effect of aluminum oxide that forms on the surface of aluminum when it is exposed to oxygen. In contrast, copper exhibits little electromigration in the bulk and at the grain boundary and instead primarily exhibits electromigration on the surface due to poor copper oxide passivation properties.

Electromigration can cause various types of failures in narrow interconnects, including void failures along the length of a line and diffusive displacements at the terminals of a line that destroy electrical contact. Both types of failure are affected by the microstructure of the line and can therefore be delayed or overcome by metallurgical changes that alter the microstructure. As previously noted, electromigration is the result of the transfer of momentum from electrons moving in an applied electric field to the ions comprising the lattice of the interconnect material. Specifically, when electrons are conducted through a metal, they interact with imperfections in the lattice and scatter. Thermal energy produces scattering by causing atoms to vibrate; the higher the temperature, the more out of place the atom is, the greater the scattering, and the greater the resistivity. Electromigration does not occur in semiconductors, but may in some semiconductor materials that are so heavily doped as to exhibit metallic conduction.

The driving forces behind electromigration are “direct force”, which is defined as the direct action of the external field on the charge of the migrating ion, and “wind force”, which is defined as the scattering of the conduction electrons by the metal atom under consideration. For simplicity, “electron wind force” often refers to the net effect of these two electrical forces. This simplification will also be used throughout the following discussion. These forces and the relation therebetween are illustrated in FIG. 1.

The electromigration failure process is predominantly influenced by the metallurgical-statistical properties of the interconnect, the thermal accelerating process, and the healing effects. The metallurgical-statistical properties of a conductor film refer to the microstructure parameters of the conductor material, including grain size distribution, the distribution of grain boundary misorientation angles, and the inclinations of grain boundaries with respect to electron flow. The variation of these microstructural parameters over a film causes a non-uniform distribution of atomic flow rate. Non-zero atomic flux divergence exists at the places where the number of atoms flowing into the area is not equal to the number of atoms flowing out of that area per unit time such that there exists either a mass depletion (divergence>0) or accumulation (divergence<0), leading to formation of voids and hillocks, respectively. In such situations, failure results either from voids growing over the entire line width, causing line breakage, or from extrusions that cause short circuits to neighboring lines.

The thermal accelerating process is the acceleration process of electromigration damage due to a local increase in temperature. A uniform temperature distribution along an interconnect is possible only absent electromigration damage. Once a void is initiated, it causes the current density to increase in the area around the void due to the reduction in the cross-sectional area of the conductor. The increase of the local current density is referred as “current crowding.” Since joule heating, or “self-heating”, is proportional to the square of current density, the current crowding effect leads to a local temperature rise around the void that in turn further accelerates the void growth. The whole process continues until the void is large enough to result in a line break.

Healing effects are the result of atomic flow in the direction opposite to the electron wind force, i.e., the “back-flow,” during or after electromigration. The back-flow of mass is initiated once a redistribution of mass has begun to form. Healing effects tend to reduce the failure rate during electromigration and partially heals the damage after current is removed. Nonhomogenities, such as temperature and/or concentration gradients, resulting from electromigration damage are the cause of the back-flow.

The effects of electromigration may be slow to develop; however, if an electromigration problem exists, the progress toward a fault is inexorable. The results of an electromigration problem are illustrated in FIGS. 2 and 3. Before current is applied to a section of an IC chip that is first powered up, the metal comprising the interconnects thereof is uniformly distributed, as illustrated in FIG. 2, which illustrates a side view of an interconnect 200. However, in a section of metal that is at risk for electromigration, the mass transport of metal, which occurs in the direction of average current, represented in FIG. 3 by an arrow 301, results in metal moving from a first end 302a of the section to a second end 302b thereof. At some future time, depending on the amount of current flowing through and the thickness of the interconnect 200, electromigration will result in the formation of a void 304 at the first end 302a and a hillock 304 at the second end 302b. Eventually, as previously described, this migration of metal from one end of the wire to the other will result in a failure of the interconnect 200.

As also previously noted, self-heating contributes to the electromigration and actually affects the surrounding wires as well. As a wire carries current, it will heat up, thereby lowering the limits for electromigration in surrounding wires as well as the wire under consideration. It is important, therefore, to consider the effects of both electromigration and self-heating (collectively “EM/SH”) when analyzing and verifying the reliability of an IC chip design.

Typically, circuit analysis tools (including, e.g., the EM/SH analysis tools) often require logic configuration to properly analyze the circuits in VLSI design. As VLSI designs continue to increase in complexity, it becomes critical that the logic configuration information relating to a circuit design be presented in an efficient manner.

### SUMMARY

One embodiment is a method for optimizing relationships between logic commands defining a circuit design input to an analysis tool is described. The method comprises, responsive to a determination that a value of logic level of a signal can be inferred and responsive to an attempt by the analysis tool to set the logic level of the signal to a calculated value, determining whether the calculated value is equal to the inferred value; and if the calculated value is equal to the inferred value, setting the logic level of the signal to the inferred value.

### BRIEF DESCRIPTION OF THE DRAWINGS

FIG. 1 illustrates the driving forces behind electromigration, including direct force and wind force;

FIGS. 2 and 3 illustrate the effects of electromigration on an IC chip interconnect;

FIG. 4 is a flow diagram of a reliability verification tool (“RVT”) in one embodiment;

FIG. 5 is a schematic diagram illustrating the concept of nets in a VLSI circuit; and

FIG. 6 is a flowchart of the operation of a VLSI circuit analysis tool, such as the RVT of FIG. 3, in accordance with one embodiment.

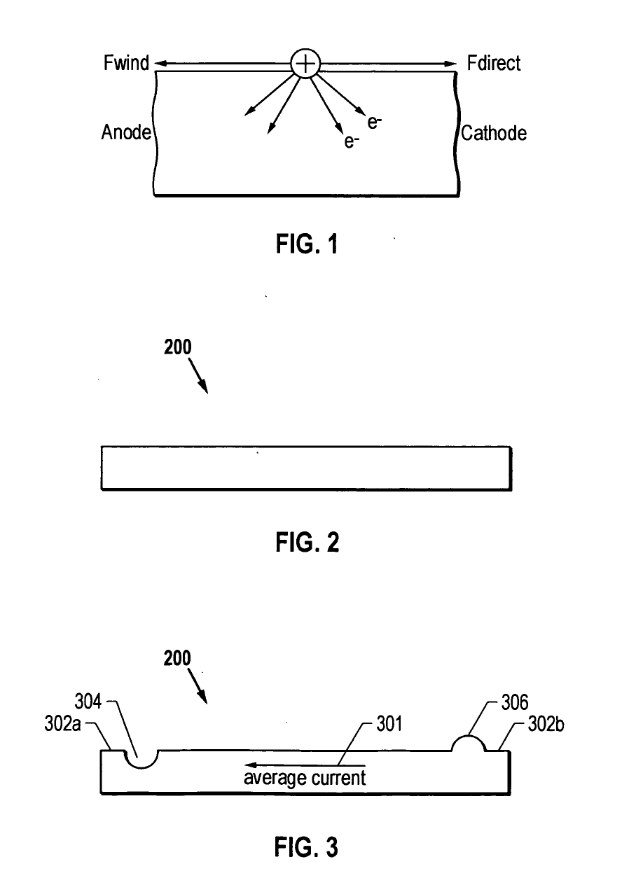

### DETAILED DESCRIPTION OF THE DRAWINGS

In the drawings, like or similar elements are designated with identical reference numerals throughout the several views thereof, and the various elements depicted are not necessarily drawn to scale.

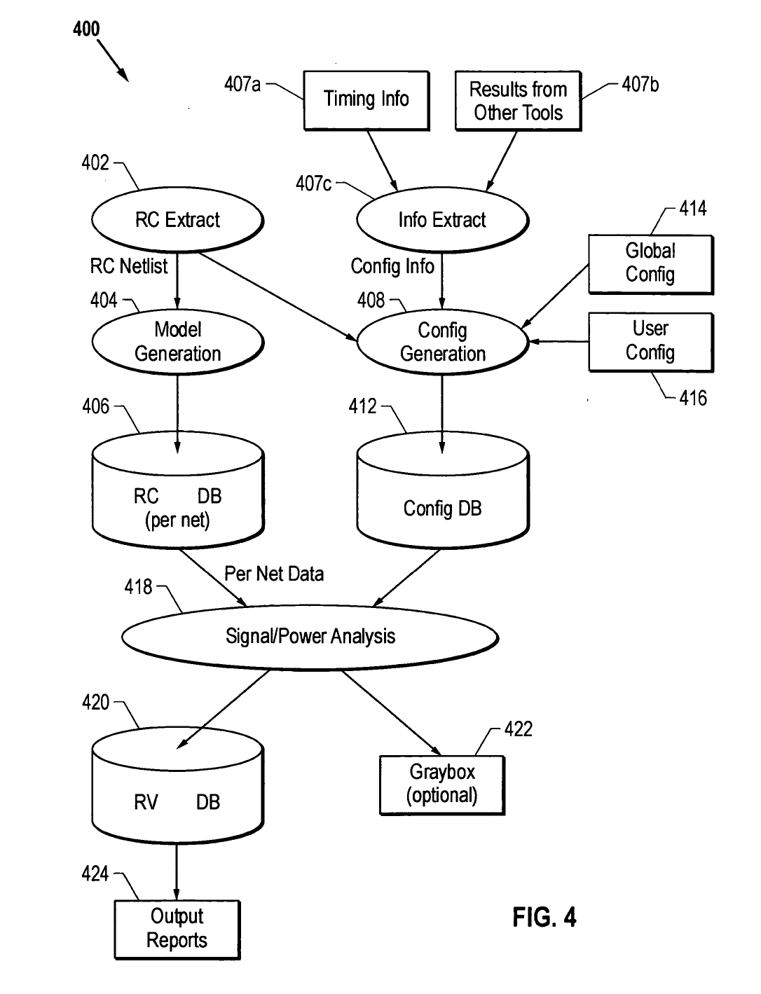

FIG. 4 is a flow diagram of one embodiment of a VLSI circuit analysis tool, specifically, a reliability verification tool (“RVT”) 400. In the illustrated embodiment, the RVT 400 is designed to find areas of an IC block layout that may have electromigration and/or self-heating (“EM/SH”) risks. The output files produced by the RVT 400 are useful for viewing violations in a text manner and a violations shapes representation can be loaded on top of the block artwork to provide a visual representation of the problem areas and the changes proposed by the RVT 400 to correct those problems.

Specifically, the RVT 400 is designed to assist designers with the challenging task of identifying potential EM/SH problem areas in their designs. Since the rules of electromigration are not always intuitive and problem areas can be hard to spot, the RVT 400 is an important tool for determining if the design has any violations that, if not discovered and corrected, could lead to future chip failure. This is due to the fact that faults that electromigration can produce develop slowly over time until the metal finally breaks.

In one embodiment, the RVT 400 provides a designer with a clear, easy-to-follow approach to identifying EM/SH violations. Theoretically, design rules should prevent most wires from risk of electromigration, but cases still exist in which there may be a problem. By running the RVT 400 on a design block, a designer can ensure that the wires in the block will be reliable in the long term and will not cause a chip failure. The RVT 400 accomplishes this by calculating the currents through each piece of metal and each contact array on the chip. It compares these currents with certain process rules describing the maximum current that a given width of metal or set of contacts may carry. Any currents that do not meet the limits are reported as violations.

In order to “calculate the currents”, as indicated above, the RVT 400 may be run in either “signal” or “power” mode to analyze metal connecting signals or to analyze the power grid. These two runs are performed separately to give better capacity and performance. In signal analysis, the RVT 400 first separates the chip into individual stages. A stage is a set of resistors that connect one or more driver FETs (i.e., those FETs that are connected to a supply) to the gates of one or more receiver FETs. These connections may pass through the channels of any number of pass FETs in the process. The RVT 400 takes each of these stages and attempts to simulate the likely combinations of on and off FETs, as dictated by logic configuration, taking the worst case currents determined over all of the simulations. The currents are then checked against the EM/SH rules.

In power analysis, the RVT 400 treats each power grid rail as its own stage. It uses the current through FETs connected to the rail determined in a previous signal analysis run to load the power grid. After simulating the grid with the load currents, it checks the currents calculated through each resistor against the EM/SH rules.

FIG. 4 illustrates the overall flow of data and control through the RVT 400. The diagram illustrated in FIG. 4 illustrates the flow that applies to both signal and power analysis. The RVT 400 relies on a special RC extract 402 to perform its analysis. In one embodiment, the RC extract 402 provides highly detailed resistance values to enable the EM/SH rules to be applied correctly.

A Model Generation module 404 processes the extracted RC information from the RC extract 402 into an RC database (“DB”) 406 for each block. This allows easy access of the information on a per-net basis so that only the nets for a particular stage, as opposed to the entire model, need to be loaded into memory. The RC DB 406 is reused from run to run of the RVT 400 and is only regenerated when a new extract is performed.

The RVT 400 also relies on configuration information, such as timing information 407a and results from other analysis tools 407b, extracted from other sources by an info extract module 407c. These sources produce configuration files that, once extracted, are read in by a configuration generation phase 408 of the RVT 400. As previously noted, the extracted configuration information input to the configuration generation phase 408 may include information extracted from circuit annotation, timing information and additional circuit properties from transistor-level static timing analysis tool runs, information extracted from circuit recognition, and node activity factor (“AF”) information.

In one embodiment, as indicated above, the RVT 400 has the ability to read some configuration information pertaining to logical relationships within the design, such as those logic configuration commands listed below. These commands may be specified via configuration files or via annotations directly associated with schematic representations of the design. Each of the block properties' values is a list of signal names, each of which may be prefixed by “!”, indicating the opposite logic sense should be applied to that signal. The block properties include:
set_high instructs the analysis tool to set the specified net(s) to logic 1
set_low instructs the analysis tool to set the specified net(s) to logic 0
unset instructs the analysis tool to that any previous set_high or set_low information should be removed from the specified net(s)
merge_nodes instructs the analysis tool to treat all of the specified nets as having the same logical value
mutex instructs the analysis tool that exactly one of the specified nets should have a value of 1
imutex instructs the analysis tool that no more than one of the specified nets should have a value of 1
ifthen instructs the analysis tool as to the logical relationship of nets based on the state of the first net
forbid forbids the specified combination of nets

In one embodiment, as also indicated above, the RVT 400 has two methods for determining the activity factor on nodes. Both of these may be overridden by user configuration information if desired. The first such method is to use the default activity factors according to the node's type as determined by circuit recognition and a transistor-level static timing analysis tool. The second is to read explicit activity factors for each node. This can either specify a user-created file for activity factors or it may run some other tool to generate activity factors. If this method is selected, any node that does not have an activity factor explicitly specified therefore will default to one based on node type.

Similar to the Model Generation module 404, the Configuration Generation module 408 consolidates all of the configuration information at the beginning of a run and places this in a Config DB 412 for easy per-net access. The Configuration Generation module 408 reads a global configuration file 414 specified by a tool administrator and a user configuration file 416 specified by a user on a per-block basis. Both of these configuration files 414, 416, may be used to override the extracted configuration if necessary.

In addition to combining all of the configuration information together in a per-net fashion, the Configuration Generation module 408 also propagates some logic configuration through a process referred to as “transitive closure”, as described in related U.S. patent application Ser. No. ______ (Docket No. 200311735-1), which has been incorporated by reference in its entirety.

A signal/power analysis module 418 performs the main work of the RVT 400. It handles one stage at a time, calculating the currents through each resistor and applying the EM/SH rules. It generates both a Reliability Verification database (“RV DB”) 420, which contains all of the information it calculates, and an optional “graybox” description 422 for the file. The RV DB 420 is subsequently processed to generate the various output reports that users actually read. In order to improve performance, the analysis may be run on serval machines in parallel. As each stage is independent, requiring only the information on the nets it contains, the analysis is easily parallelizable.

It should be noted that when the RVT 400 generates a graybox 422 for a given block, it will create both a netlist, or “BDL”, file and also a config file containing all configuration information for the ports of the graybox. This allows various configuration (such as node types or activity factors) to be propagated up from a graybox. The graybox information is read in by the Model Generation module 404 and the Configuration Generation module 410 when the graybox 422 is used in the analysis of a parent block.

The RVT 400 generates a variety of output reports 424 such as a text file containing a list of all resistors that failed the EM/SH rules, along with any stages that were discarded. The RVT 400 also generates layout shapes that highlight the violations at each level of the hierarchy. The violations shapes are all stored as blocks along with the rest of the output files 424.

Running a power analysis using the RVT 400 relies on the user to have previously run a signal analysis with the RVT at or above the level on which a power analysis is to be run. During the RVT signal analysis, the default is to write out the average case and worst case current through all driver FETs (i.e. any FETs with a source or drain of VDD or GND) to a “signal_rvdb” file so that power analysis can use those currents. This also includes writing currents through output drivers, which means that these stages are analyzed for currents, but no EM/SH checks are done on those stages and no resistor currents are reported for them.

The average and worst case currents are calculated in the signal run as follows. The worst case current is simply the worst case current through each driver FET seen during the signal run using the same activity factors (“AF”) and drive fights (“DF”) signal run. This current will be used in the worst case RVT power analysis, which is performed on the low level metal and via layers as specified in the global configuration file 414.

Calculating the average case current is a bit more complicated. The average case current is used to check EM/SH on the upper level metal and via layers as specified in the global configuration file 414, thus it is very important to get the current for the entire stage correct and not as important to get the current for each driver FET correct. Thus, for the average case power analysis, it is not advisable to use the worst case current. The global configuration file 414 may also specify different default activity factors for different node types to use with power analysis. For example, changing the default activity factor for static nodes to 0.2 instead of using the 0.5 used for worst case signal analysis, more accurately represents the power drawn.

During an RVT power analysis run, the RVT 400 collects the driver FET currents calculated during the RVT signal run, as described above, generates a power SPICE deck, simulates that deck, checks each resistor in the simulated grid against EM/SH rules, and generates output files, including violations files, and power grayboxes if requested to do so.

In electronics, components are viewed in terms of how they move signals back and forth across wires. All components have locations that attach to wires that make a connection to other locations on other components. Accordingly, an implicit requirement of VLSI design is that components are connected and connections carry information about the relationship of the connected components.

A related concept is that of a “net”, which is a single electrical path in a circuit that has the same value at all of its points. Any collection of wires that carries the same signal between components comprises a net. Moreover, if a component passes the signal though without altering it, such as is the case with a terminal, the net continues on subsequently connected wires. Otherwise, the net terminates a component that alters the signal and a new net begins on the other side of that component. A component that passes a signal unaltered is referred to as a passive component; a component that alters a signal that passes through is referred to as an active component.

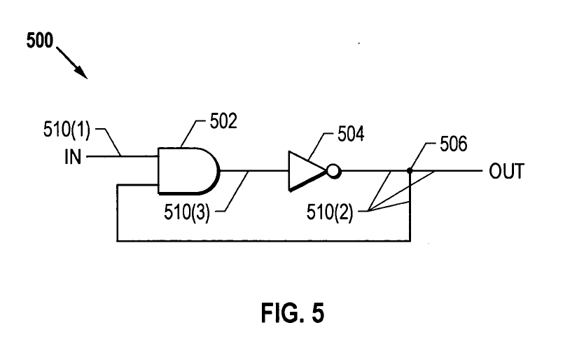

FIG. 5 further illustrates the concept of nets. As shown in FIG. 5, a circuit 500 comprises two active components, including an AND gate 502 and an inverter 504, and one passive component; i.e., a terminal 506. The circuit 500 also comprises three nets 510(1), 510(2), and 510(3). The first and second nets 510(1) and 510(2) are input and output nets, respectively. The third net 510(3) is an internal net that connects the output of the AND gate 502 to the input of the inverter 504.

Designers typically want to view an entire net to determine the path of a particular signal, which will identify the origin of the signal and the components that use the signal as input. Additionally, viewed abstractly, a circuit is merely a collection of gating components and the connections therebetween. A netlist omits the passive components and actual geometry of a circuit layout. Therefore, if a design tool is concerned only with the general functionality of a design, the collection of nets and active components supplies all of the information needed by the tool. It will be recognized that a net can also be identified by the name of a signal that traverses the net; therefore, where appropriate, the terms “net” and “signal” will be used interchangeably herein.

As previously noted, in one embodiment, there are several net logic configuration commands that can be employed by a user to configure logical relationships between different nets, or signals. These commands are used to reduce the number of possible combinations of drivers that need to be simulated by eliminating those that cannot logically occur. Net logic configuration commands commonly implemented by VLSI circuit analysis tools, such as the RVT 400, and their corresponding operations are set forth below again for convenience. It should be noted that the terms “net” and “signal” as used herein are interchangeable.
set_high instructs the analysis tool to set the specified net(s) to logical 1
set_low instructs the analysis tool to set the specified net(s) to logical 0
unset instructs the analysis tool to that any previous set_high or set_low information should be removed from the specified net(s)
merge_nodes instructs the analysis tool to treat all of the specified nets as having the same logical value
mutex instructs the analysis tool that exactly one of the specified nets should have a value of
imutex instructs the analysis tool that no more than one of the specified nets should have a value of 1
ifthen instructs the analysis tool as to the logical relationship of nets based on the state of the first net
forbid used to forbid the specified combination of nets

In each of the commands, a “!” preceding a net name is used to indicate the inverse of a net, such that !A is the inverse of A. For example, the following command:
forbid A !B C D
   is used to forbid the specified combination of control nets. In particular, the immediately preceding example forbids the state A=1, B=0, C=1, D=1. The command:
ifthen !A B
   indicates that if net A is 0, then net B is 1. The command:
mutex A B C
   indicates that one and only one of nets A, B, and C must be equal to 1. In contrast, the command:
imutex A B C
   indicates that none or one of nets A, B, and C must be equal to 1. It will be recognized that the above-noted commands could be represented differently. For example, the command:
ifthen !A B
   could also be represented:
if0then1 A B.
   Similar alternative representations may be available for the remaining commands.

In accordance with one embodiment, to simplify storage and processing of logic configuration information, the commands are broken down, or decomposed, into more primitive logical relationships, as illustrated in Table I below.

TABLE I

| THE COMMAND | CAN BE REPRESENTED AS |
|---|---|
| mutex n1 n2 . . . nn | imutex n1 n2 . . . nn |
| | forbid !n1 !n2 . . . |
| | !nn |
| imutex n1 n2 . . . nn | ifthen n1 !n2 . . . !nn |
| | ifthen n2 !n1 !n3 . . . |
| | !nn |
| | . |
| | . |
| | . |
| merge_nodes n1 n2 . . | ifthen n1 n2 . . . nn |
| . nn | ifthen !n1 !n2 . . . |
| | !nn |
| | ifthen n2 n1 n3 . . .nn |
| | ifthen !n2 !n1 !n3 . . |
| | . !nn |
| forbid n1 n2 | ifthen n1 !n2 |
| | ifthen n2 !n1 |

It should be noted that the “forbid” case listed above is a special case for a two-net forbid. It will also be recognized that the representation of the mutex command set forth above includes an imutex command, which will be further broken down as illustrated above.

Once the commands are broken down into their primitive commands (basically comprising ifthen and forbid statements), the resulting logic configuration may be stored in the Config DB 412 (FIG. 4) for use as follows. First, for ifthen commands, each net has two lists associated with it. The first is a list of all nets that are affected and the levels to which the listed nets should be set if the net is true (i.e., logical 1); this is referred to as the “ifilist” of the net. The second is a similar list covering the case in which the net is false (i.e., logical 0); this is referred to as the “if0list” of the net. Each forbid is represented as a list of nets and their corresponding levels that are forbidden. Each net has a forbid list of which it is a member.

As will be described in greater detail below, in one embodiment, the application of forbid lists and decomposed mutexed signals is delayed until the last signal in the list has a “set” operation performed thereon. In particular, since each net in a circuit has a data structure that includes lists of related signals, particularly, lists that indicate combinations of signal states that cannot occur (i.e., forbid lists), the embodiment updates the state of signals in the list only when a set operation is performed on the last “unset” signal in the list.

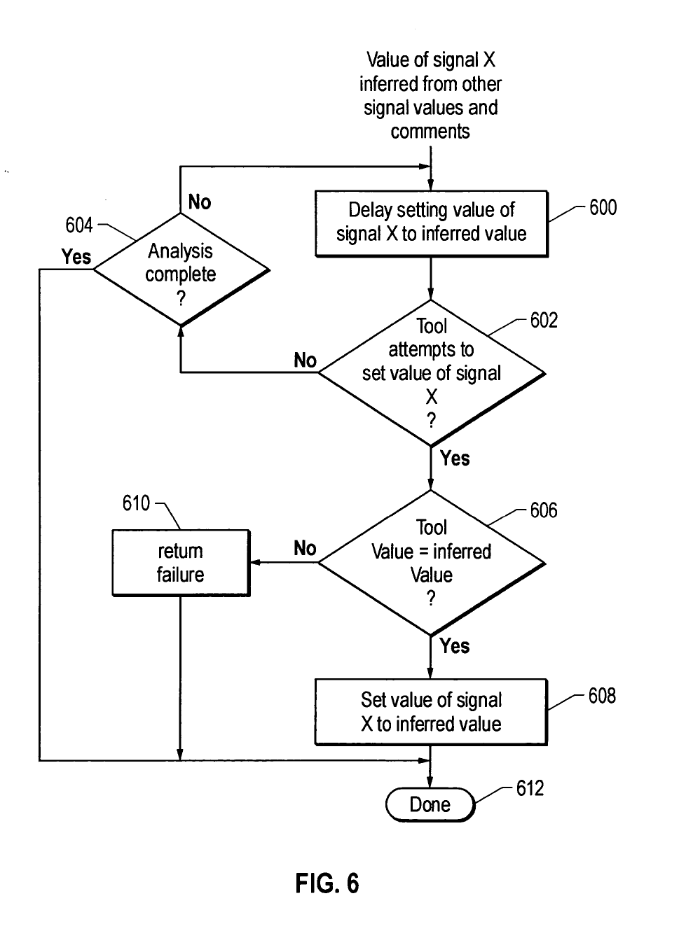

FIG. 6 is a flowchart illustrating operation of a VLSI circuit analysis tool, such as the RVT 400, in accordance with one embodiment. Execution begins in step 600 responsive to the value of a signal, referred to as signal X, being inferred from the value of other signals and commands. In step 600, the tool delays setting the value of signal X to the inferred value. In step 602, a determination is made whether the tool has made an attempt to set the value of the signal X to a logic level calculated during the ongoing circuit analysis being performed by the tool. If a negative determination is made in step 602, execution proceeds to step 604, in which a determination is made whether analysis of the circuit under consideration has been completed. If not, execution returns to step 600.

If a positive determination is made in step 602, execution proceeds to step 606, in which a determination is made whether the value to which the tool is attempting to set the signal X is the same as the inferred value for the signal X. If a positive determination is made in step 606, execution proceeds to step 608, in which the value of the signal X is set to the inferred value; otherwise, execution proceeds to step 610, in which the signal X is not set and a failure to set the signal X is returned. Upon the completion of any of steps 604, 608, or 610, execution terminates in step 612 with respect to the signal X.

It will be recognized that the process illustrated in FIG. 6 is performed with respect to each signal with respect to which a value can be inferred but that the relevance to the circuit of which has not been determined as of the time the value is inferred.

The following example is provided for further clarification. Consider the command:
forbid !A !B !C
   The command is stored as a list of referenced signals and associated values with each signal (A, B, and C) referencing the list. If, in the course of an analysis, a VLSI circuit analysis tool, such as the RVT 400, sets the logic value of A and B to 0, then it can be inferred that C must be a logical 1, since the state ABC=000 is forbidden.

Consider further the command:
ifthen C D E F G H I J K L
   This means that if the value of C is a logical 1, then all of the other signals must be set to logical 1. In the example above, if the analysis tool sets the value of C to logical 1 because of a forbid statement, then the tool must update the states of the signals D-L as potentially affecting the analysis. However, it is possible that the signal C is not pertinent to the circuit currently under analysis and as such, there is no need to update its state when its value is inferred. The embodiments disclosed herein will correctly handle this station by delaying updating the state of the signal C until such time as it is encountered in the circuit being analyzed. If the signal C is pertinent to the current circuit analysis, then the tool will attempt to set the logic value of C. If an attempt is made to set the value to logical 0, the embodiment will return a failure to set the logical value, since the state ABC=000 is forbidden. If no attempt is made to set the state of C to a logical 1, then the embodiment has again saved the time needed to update any related signals D-L.

As a result, the embodiments described herein provide an increase in the speed of an analysis tool that relies on this relationship information, since unnecessary propagation of logic values through relationships is avoided.

An implementation of the invention described herein thus provides system and method for facilitating efficient application of logical configuration information in VLSI circuit analysis tools. The embodiments shown and described have been characterized as being illustrative only; it should therefore be readily understood that various changes and modifications could be made therein without departing from the scope of the present invention as set forth in the following claims.

1. A method for optimizing relationships between logic commands defining a circuit design input to an analysis tool, the method comprising:
responsive to a determination that a value of logic level of a signal can be inferred:
responsive to an attempt by the analysis tool to set the logic level of the signal to a calculated value, determining whether the calculated value is equal to the inferred value; and
if the calculated value is equal to the inferred value, setting the logic level of the signal to the inferred value.

2. The method of claim 1 further comprising:
if the calculated value is not equal to the inferred value, preventing the analysis tool from setting a logic level of the signal.

3. The method of claim 2 further comprising, responsive to the preventing, generating an error message indicating that a logic level of the signal has not been set.

4. The method of claim 1 wherein a value of the logic level of the signal is inferred from logic levels of other signals of the circuit design as affected by logic commands applied thereto.

5. A method for optimizing relationships between logic commands defining a circuit design input to an analysis tool, the method comprising:
responsive to a determination that a value of logic level of a signal can be inferred:
responsive to an attempt by the analysis tool to set the logic level of the signal to a calculated value, determining whether the calculated value is equal to the inferred value;
if the calculated value is equal to the inferred value, setting the logic level of the signal to the inferred value; and
if the calculated value is not equal to the inferred value, refraining from setting a logic level of the signal.

6. The method of claim 5 further comprising, responsive to the refraining, generating an error message, wherein the error message indicates that a logic level of the signal has not been set.

7. The method of claim 5 wherein a value of the logic level of the signal is inferred from logic levels of other signals of the circuit design as affected by logic commands applied thereto.

8. A circuit analysis tool for optimizing relationships between logic commands defining a circuit design input to the tool, the tool comprising:
means responsive to a determination that a value of logic level of a signal can be inferred and to an attempt by the analysis tool to set the logic level of the signal to a calculated value for determining whether the calculated value is equal to the inferred value; and
means responsive to the calculated value being equal to the inferred value for setting the logic level of the signal to the inferred value.

9. The tool of claim 8 further comprising:
means responsive to the calculated value not being equal to the inferred value for preventing the analysis tool from setting a logic level of the signal.

10. The tool of claim 9 further comprising means responsive to the means for preventing for generating an error message indicating that a logic level of the signal has not been set.

11. The tool of claim 8 wherein a value of the logic level of the signal is inferred from logic levels of other signals of the circuit design as affected by logic commands applied thereto.

12. A circuit analysis tool for optimizing relationships between logic commands defining a circuit design input to the tool, the tool comprising:
means responsive to a determination that a value of logic level of a signal can be inferred and to an attempt by the analysis tool to set the logic level of the signal to a calculated value for determining whether the calculated value is equal to the inferred value;
means responsive to the calculated value being equal to the inferred value for setting the logic level of the signal to the inferred value; and
means responsive to the calculated value not being equal to the inferred value for refraining from setting a logic level of the signal.

13. The tool of claim 12 further comprising means responsive to the means for refraining for generating an error message indicating that a logic level of the signal has not been set.

14. The tool of claim 12 wherein a value of the logic level of the signal is inferred from logic levels of other signals of the circuit design as affected by logic commands applied thereto.

15. A computer-readable medium operable with a computer for optimizing relationships between logic commands defining a circuit design input to an analysis tool, the medium having stored thereon:
computer-executable instructions responsive to a determination that a value of logic level of a signal can be inferred and to an attempt by the analysis tool to set the logic level of the signal to a calculated value for determining whether the calculated value is equal to the inferred value; and
computer-executable instructions responsive to the calculated value being equal to the inferred value for setting the logic level of the signal to the inferred value.

16. The medium of claim 15 further having stored thereon:
computer-executable instructions responsive to the calculated value not being equal to the inferred value for preventing the analysis tool from setting a logic level of the signal.

17. The medium of claim 16 further having stored thereon computer-executable instructions responsive to the preventing for returning an error message indicating that a logic level of the signal has not been set.

18. The medium of claim 15 wherein a value of the logic level of the signal is inferred from logic levels of other signals of the circuit design as affected by logic commands applied thereto.

19. A computer-readable medium operable with a computer for optimizing relationships between logic commands defining a circuit design input to an analysis tool, the medium having stored thereon:
computer-executable instructions responsive to a determination that a value of logic level of a signal can be inferred and to an attempt by the analysis tool to set the logic level of the signal to a calculated value for determining whether the calculated value is equal to the inferred value;
computer-executable instructions responsive to the calculated value being equal to the inferred value for setting the logic level of the signal to the inferred value; and
computer-executable instructions responsive to the calculated value not being equal to the inferred value for refraining from setting a logic level of the signal.

20. The medium of claim 19 further having stored thereon computer-executable instructions responsive to the refraining for generating an error message, wherein the error message indicates that a logic level of the signal has not been set.

21. The medium of claim 19 wherein a value of the logic level of the signal is inferred from logic levels of other signals of the circuit design as affected by logic commands applied thereto.
